(19) United States
(12) Patent Application Publication
(10) Pub. No.: US 2007/0061830 A1
(43) Pub. Date: Mar. 15, 2007

(54) Audio-based tracking system for IPTV viewing and bandwidth management

(75) Inventor: Harry Chang, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/226,647

(22) Filed: Sep. 14, 2005

(51) Int. Cl. H04N 7/16

(52) U.S. Cl. 725/9

(57) ABSTRACT

In accordance with one aspect of the present invention, a method determines whether a display device is being watched. A sound is emitted from the display device that is playing a content, and the sound is detected at a sensor that is distinct from the display device. A determination whether the display device is being watched is based upon whether the sound that is detected at the sensor compares favorably with the content. In accordance with another embodiment of the present invention, a set top box determines whether a display device is being watched. The set top box comprises an output (containing a sound) to provide content to a display device, a first input to receive an electronically readable signal corresponding to the sound from a sensor that is distinct from the display device, and a processor to determine whether the display device is being watched based upon whether the electronically readable signal compares favorably with the content.

### BACKGROUND OF THE INVENTION

1. Field of the Invention

The present invention relates to the field of to broadcast distribution of video/audio contents provided over a network and more specifically to determining usage of individual contents distributed or provided over the network.

2. Description of the Related Art

Accurately tracking and determining which TV/cable channels or programs users or subscribers actually watch on a large scale basis is extremely important to the ratings of TV programs offered by broadcasting/cable networks. The rating data such as that from Nielsen Media Research is so valuable that almost all major players in the television industry spend tens of millions of dollars to purchase this TV rating data which in turn directly influences how billions of advertising dollars are spent each year in the U.S. market. However, tracking such viewing data involving thousands of households throughout the U.S. is an expensive and a problematic process. For example, the Nielsen rating system, the de facto national measurement service for the television industry, uses a people-based “meter” installed in 5,000 or so “Nielsen's households” randomly selected from households in the U.S. that have at least one person watching TV. The data collected in a small interval, typically a 15-minute interval are based on a paper diary system. It is widely acknowledged that such a manual process is not only error prone but also inadequate to track viewers' television viewing habits in today's Internet era.

With the arrival of Internet Protocol (IP) based TV (IPTV), which may provide services to tens of millions of households in the U.S. over the next decade, there are alternative ways to automatically track which TV programs are watched at the IPTV users or households. Servers within a data network may monitor content that is broadcast to user operated devices, such as set top boxes (STBs), in homes and businesses across the country. The STBs may include computer processors or other intelligent devices and software. Such devices are generally connected to television sets or computer monitors or other video display devices, where the broadcast content is displayed.

Some viewers, however, turn off their television sets and computer monitors without turning off their STBs. For example, a viewer may leave home or may turn off a television set while making a telephone call, without turning off the STB. Many STBs have a “warm up” time, and leaving the STB on all the time allows the user to begin watching broadcast content immediately upon turning on the television set, without having to wait additional time to allow the STB to warm up. In an IPTV environment, the STB is typically powered all the time in order to reduce “warm-up” time. There typically is no feedback from the television set to the STB, the STB (and, consequently, the IPTV network control system) cannot determine that the television set has been turned off. The STB can determine some viewer-initiated events, such as a channel change or a Video On Demand (VoD) purchase. However, if the user decides to turns off the IPTV set without turning off the STB, then neither the STB nor the IPTV network content feed can detect the discontinuance of the viewing. This may result in incorrectly reporting that the program is being watched.

### SUMMARY OF THE INVENTION

In accordance with one aspect of the present invention, a method of the present invention determines whether a display device is being watched. A sound is emitted from the display device that is playing content, and the sound is detected at a sensor that may be distinct from the display device. A determination whether the display device is being watched may be based upon whether the sound that is detected at the sensor compares favorably with the content delivered to the display device. In accordance with another embodiment of the present invention, a set top box determines whether a display device is being watched. The set top box includes an output (containing a sound) to provide content to a display device, a first input to receive an electronically readable signal corresponding to the sound from a sensor that is distinct from the display device, and a processor to determine whether the display device is being watched based upon whether the electronically readable signal compares favorably with the content.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 is a schematic diagram depicting an automatic audio-based viewing tracking system for IPTV programming, delivering and monitoring contents, in accordance with one embodiment of the present invention.

FIG. 2 is a flowchart depicting a method for determining whether a display device is in use, in accordance with another embodiment of the present invention.

FIG. 3 is a schematic representation of a portion of a set top box, in accordance with yet another embodiment of the present invention.

FIG. 4 is a schematic diagram of a system, in accordance with still another embodiment of the present invention.

### DETAILED DESCRIPTION OF THE INVENTION

In view of the above, the present invention through one or more of its various aspects and/or embodiments is presented to provide one or more advantages, such as those noted below.

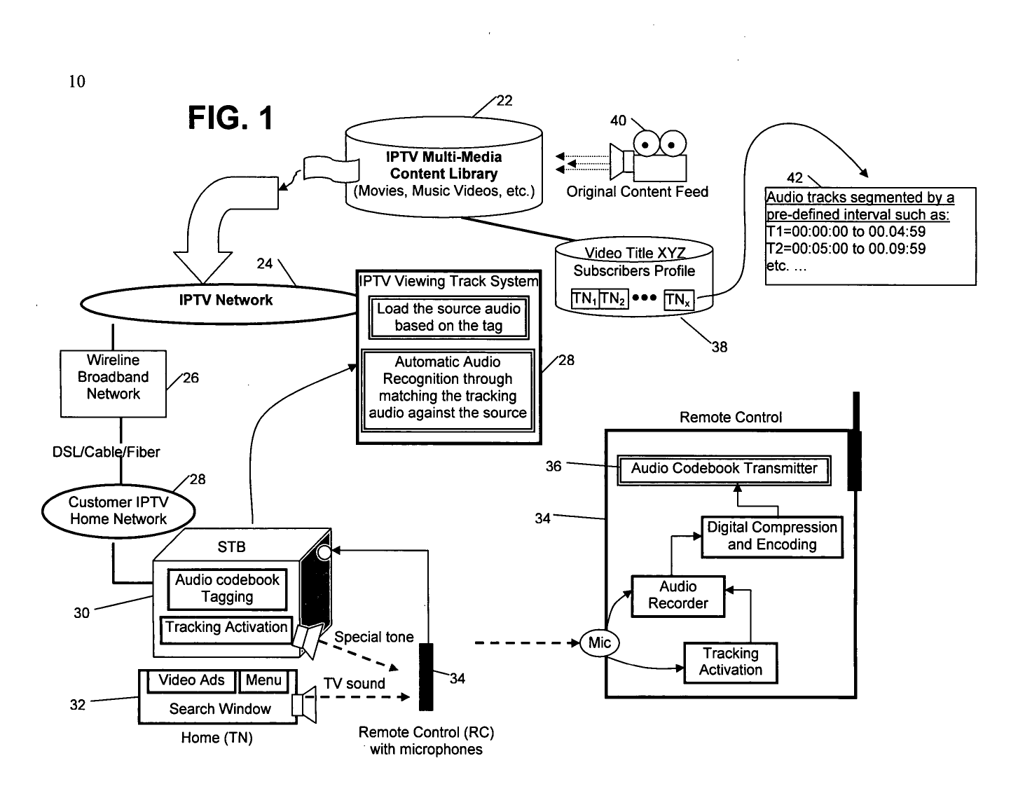

FIG. 1 is a schematic diagram depicting an automatic audio-based viewing tracking system 10 for IPTV programming, delivering and monitoring, in accordance with one embodiment of the present invention.

The system 10 may include an IPTV Multi-Media Content Library (Movies, Music Videos, etc.) 22 that may receive an Original Content Feed 40 from a content source, such as a television station, satellite or cable company, film library, music video database, audio-only content database, video-only content database, or other source of programming content. The Original Content Feed 40 may contain content, such as a movie, which is stored digitally within the IPTV Multi-Media Content Library 22. It will be appreciated that the Original Content Feed 40 is merely one example of a possible source of such content, and any source of content may be substituted without departing from the spirit of the described embodiment.

The IPTV Multi-Media Content Library 22 may store, for example, content corresponding to a Video Title XYZ 38. The content may contain an audio track. Regardless of whether the content contains an audio track, a supplemental audio track may be added. Accordingly, the audio track may include a supplemental audio track that is added within the IPTV Multi-Media Content Library 22. The audio track may be, but need not be, audible to a human ear; ultrasound (i.e. sound that is to high in frequency for a human ear to hear) and infrasound (sound that is too low in frequency for a human ear to hear) may be used. Even if the content is silent, therefore, the audio track may have an audio content.

A user may decide to watch the contents associated with Video Title XYZ 38. Whenever at least one customer seeks to play content associated with a particular title, such as Video Title XYZ 38, the IPTV Multi-Media Content Library 22 provides the content associated with the Video Title XYZ 38 (i.e., at least one video stream and/or at least one audio stream) to an IPTV network 24, and also provides at least one segment of an audio track to a subscriber module 38.

The segment that is provided to the subscriber module 38 need not be copy of the audio track. The segment may be, for example, an encrypted version of the audio track or a compressed version of the audio track. The segment may include some identifying information, such as a channel number, a time stamp, a set top box identifier and/or a server cluster identifier corresponding to a video distribution server cluster. Of course, the segment may include a complete version of the audio track, if desired.

The content that is provided to the IPTV network 24 may be provided via a wireline broadband network 26, such as a Digital Subscriber Loop (DSL) network, a cable distribution network, a fiber-optic distribution network, or a satellite distribution network, to the Customer IPTV Home Network 28. The content may be provided to a set top box (STB) 30.

The set top box 30 may also provide the content, or a portion of the content, to a display device such as a television set, IPTV television set, computer monitor, projection television device, audio-only stereo system or loudspeaker, or other display device. The display device may be associated with a Telephone Number (TN). It will be appreciated that the set top box and the display device may be combined into an integrated device, such as a computer system, or may be distinct devices.

The display device may provide a sound in response to the content. The sound may be, for example, ordinary audible audio content, or may contain additional content that is encoded within the audible audio content. The sound may also include ultrasonic or infrasonic content, too high or too low for a human ear to detect.

A remote control (RC) 34 may contain at least one microphone that can detect the sound from the display device. If the set top box also provides the special tone, then the remote control 34 may also detect the special tone. The remote control 34 may also contain a tracking activation module that can conserve energy (that is, battery life) of the remote control 34 by activating the remote control 34 only when a sound (and a special tone, when present) are being emitted from the display device.

The remote control 34 may also include an antenna that can transmit an electronically detectable signal to the set top box 30. The set top box 30 may forward the audio codebook to the IPTV network 24 via the Customer IPTV Home Network 28 and the wireline broadband network 26.

In accordance with one embodiment of the present invention, the remote control 34 contains an audio recorder, a digital compression and encoding module, and an audio codebook transmitter. The audio recorder may digitally record the sound, and may also record the special tone (when present). For example, the audio recorder may record all sound for a period of five seconds, or for a period of five minutes. The audio recorder may have a specific frequency range that it can record, or may record all frequency ranges of sound. The audio recorder may also select one second from each ten seconds, to obtain a 1-to-10 compression. If the special tone is present, then the audio record may also record the special tone.

The digital compression and encoding module may select various bits that are recorded within the audio recorder for compression and encoding. Compression may include simply selecting one bit of each bit string within the audio recorder, or may include more complex compression formula. The compression may be data-specific, such that some data is more compressed than other data. Encryption may be specific to the remote control 34, such that interference may be reduced if a second remote control is in use near the set top box 30.

The audio codebook transmitter 36 may be configured to provide a digitally compressed audio codebook, or simply “audio codebook,” as the electronically detectible signal. The electronically detectable signal may be a digitized and sampled version of the audio track, or a portion thereof. The electronically detectable signal may also include additional information corresponding to the set top box 30.

In accordance with another embodiment of the present invention, much of the functionality of the audio recorder, digital compression and encryption, and audio codebook transmitter 36 may be located in the set top box 30, rather than the remote control 34. The remote control 34 may be configured simply to retransmit all sound, or a portion of whatever sound it may receive. The functions of the audio recorder and the digital compression and encoding module may be located within the set top box, and the audio codebook transmitter may be replaced with a simple radio transmitter. The audio codebook may be generated within the set top box 30, which may then forward the audio codebook to the IPTV network 24 via the IPTV Viewing Track System 28 and the wireline broadband network 26. Accordingly, a cost of manufacturing replacement remote controls may be reduced.

In accordance with still another embodiment of the present invention, much of the functionality of the audio recorder, digital compression and encryption, and audio codebook transmitter 36 may be located in another component of the IPTV network 24, such as a server (e.g., a D-server), rather than the remote control 34 or the set top box 30. The remote control 34 may be configured simply to retransmit all sound, or a portion of whatever sound it may receive, and the set top box 30 may simply retransmit the sound (or portion of the sound) to the IPTV network 24. The audio codebook may be generated within the IPTV network 24, which may have more processing power. The server may already have processing power corresponding to other services, such as telephone services. Allowing the server, rather than the remote control 34, to process the sound may allow the remote control 34 to be integrated into another device, such as a cordless telephone handset, in conjunction with other services also provided by the video content distributor.

The set top box 30 may contain an audio codebook tagging module and a tracking activation module. In accordance with various embodiments of the present invention, the audio codebook tagging module may insert information into either the sound that is provided to the display device, the sound that is emitted from loudspeakers inserted into the set top box 30 itself, or the electronically detectable signal received from the remote control 34.

The audio codebook may be provided to a processor. Since the audio codebook may contain sound that is provided by the display device when the display device is on, and may not contain any such sound when the display device is off, the audio codebook may be examined by the processor to determine whether the display device is on or off.

If the processor determines that the display device is on, then the processor may compare the audio codebook to a segment of the audio track received from the subscriber profile module 38. The processor may compare the audio codebook to all segments, or to a portion of the segments, that are contained within the IPTV Multi-Media Content Library 22. Using correlations, minimum Hamming distances, and/or other techniques, the processor may determine which channel is being watched at the display device.

The processor may be implemented as a single microprocessor, or may be implemented as multiple microprocessors located at a single location or at several locations. The processor may include, for example, the remote control 34, the set top box 30, and the IPTV network 24. A downstream signal from the IPTV network 24 to the display device includes content for display on the display device, and an upstream signal from the display device to the IPTV network 24 (via the remote control 34) includes information that is present only when the display device is on. A determination may thus be made whether the display device is on. If the display device is on, then further determinations may be made when the display has been turned on, and for how long the display device has been on.

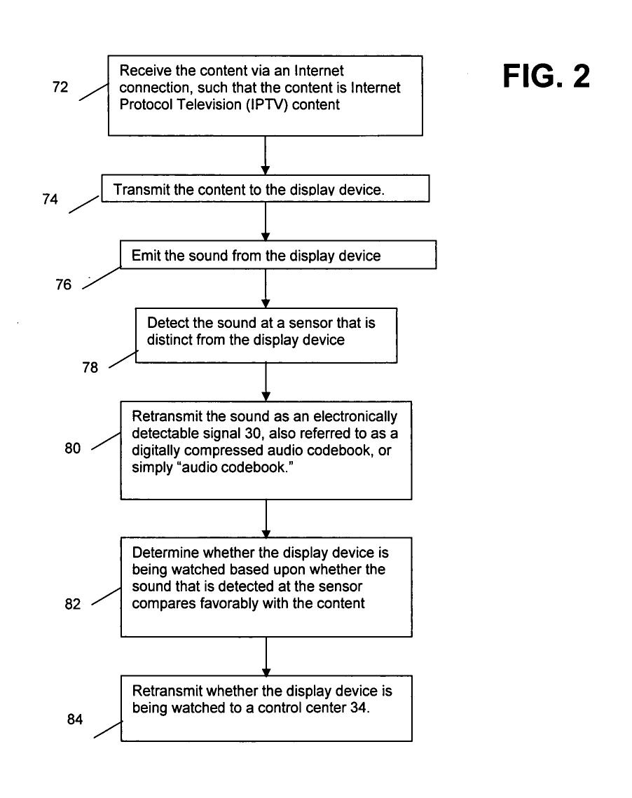

FIG. 2 is a flowchart depicting a method for determining whether a display device is being watched, in accordance with one embodiment of the present invention. The method includes receiving the content via an Internet connection, such that the content is Internet Protocol Television (IPTV) content 72. For example, the content may be a movie, television program, or other video and/or audio content received from a control center of a broadcasting company.

Generally, the content may contain an audio component, and the audio component may be adequate without a need for additional audio content. However, additional audio content may be added to the content, either at the broadcasting company control center, at a server through which the content passes, or at a set top box. For example, a system that includes a set top box may add additional audio content at the set top box. The set top box may be, for example, an IPTV set top box (STB) with a capability to upload packetized audio stream. The additional audio content may be audible, such as a tone or chime, or may be inaudible, such as an ultrasonic tone at a frequency that is not ordinarily audible to a human ear. The additional audio content may be encoded to identify the broadcast company, server, or set top box through which the content passes, and may be added continuously or periodically. The additional audio content may include a serial number of the set top box, and may also include a time stamp.

The method depicted in the flowchart of FIG. 2 also includes transmitting the content to the display device 74. For example, the set top box may be coupled to a television set, a computer, or other display device that is capable of displaying or playing the content, including the audio content. Since the content contains the audio component and/or the additional audio content, the display device may present or play the audio component, including the additional audio content. The content may be delivered to the display device using traditional video delivery techniques, such as coaxial cables and/or S-video cables, or may be delivered wirelessly, using WiFi, Bluetooth, or other video delivery techniques.

The method depicted in the flowchart of FIG. 2 also includes emitting the sound from the display device 76. The “sound” includes the audio component, and any additional audio content that may have been added. In other words, a sound is emitted from the display device that is playing content. The sound may be an ultrasound that is not audible to a human ear, and may be emitted even if the display device is set to mute. The emitting of any inaudible component of the sound may be amplified such that the inaudible component of the sound may be detected anywhere throughout a room in which the display device is located, regardless of any volume or loudness setting a user may have set in the display device. The sound contains a signal unique to the display device, and that therefore may be audited to identify the set top box that sent the sound to the display device.

The sound may be emitted in a manner that describes the content, or that describes a channel or other information related to the content. For example, the sound may be emitted at a frequency that depends on a channel number. Each channel number may be assigned a frequency (either audible or inaudible to the human ear), and the sound may contain additional audio content that may include a tone having a frequency corresponding to a channel that is being watched, played or displayed. The sound may also be emitted as a series of pulses having a pulse frequency corresponding to the channel that is being watched. The sound may be configured to include other parameters, such as mean frequency, mean amplitude, or statistical information describing the video content, such as the channel that is being watched.

The sound may also include a command to one or more sensors that may be capable of detecting the sound. The command may include, for example, a sampling rate, a transmission amplitude, a transmission frequency, or a delay time (each of which is described in greater detail below). Depending on tracking requirements for individual IPTV markets, the set top box may be programmed to cause the display device to emit a sound, or a special audio signal, periodically (for example, every 5 minutes).

The method depicted in the flowchart of FIG. 2 also includes detecting the sound at a sensor that is distinct from the display device 78. The sensor may be a microphone or a collection of microphones. If the sensor is a collection of microphones, the microphones may be directionally oriented in different directions.

The sensor may reside within a handset remote control. If the sound has been emitted with sufficient amplitude (regardless of whether the sound is audible to the human ear) and if the handset remote control is located within the room in which the display device is located, the sensor may be able to detect the sound. If desired, a sensor may alternatively be located within the set top box. The sensor may be located wherever the sensor may be likely to detect the sound. The handset remote control may be an IPTV remote control (RC) with a built-in microphone, or with one or more omni-directional microphones built into the RC. The sensor may be activated by the sound, and may also record the sound within a memory residing within the handset remote control. The use of omni-directional microphones on the handset remote control may allow a better perception of sound from the display device regardless where handset remote control is placed.

To conserve the battery, the handset remote control may record only a very small slice of sound, for example, a quarter of a second at a time. The handset remote control may convert each slice of the sound recorded into a digital format and compress it to retain only whatever information may be required for audio recognition.

If desired, several sensors may be used. For example, a home may contain a first television set in a living room and a second television set in a bedroom. Each of the first television set and the second television set may have a set top box coupled thereto and a handset remote control corresponding thereto. The television set in the bedroom may be off, and the television set in the living room may be on. The handset remote control corresponding to the first television set in the living room may be under a sofa cushion capable of muffling the sound, such that the handset remote control is unable to detect the sound from the first television set. Nevertheless, the sound may have sufficient loudness to be detected at the second set top box, i.e., the set top box corresponding to the television set in the bedroom. Even though the second television set is off, the handset remote control corresponding thereto may detect the sound emitted from the first television set.

The method depicted in the flowchart of FIG. 2 also includes retransmitting the sound as an electronically detectable signal 80, also referred to as a digitally compressed audio codebook, or simply “audio codebook.” The electronically detectable signal may be a digitized and sampled version of the sound, and may be retransmitted to the set top box. If desired, only a portion of the sound may be retransmitted. For example, the electronically detectable signal may include samples taken only periodically from the sound. The handset remote control may send the digitally compressed audio codebook to the set top box via a wireless connection such as WiFi.

Since the sound may include a command to one or more sensors that may be capable of detecting the sound, the sensor may be configured to retransmit the sound as an electronically detectable signal in accordance with the command. For example, several sensors and several display devices may be located within range of one another. In homes and apartment complexes having many television sets located near one another, conflict resolution among the transmission of the electronically detectable signals may be necessary. If a set top box detects collisions from multiple sensors, the set top box may command a change of sampling rate, transmission amplitude, transmission frequency, or delay time to a particular sensor. For example, if a particular channel is being displayed on two television sets within a home, a first sensor may be required to transmit the electronically detectable signal immediately after detecting the sound, while a second sensor may be required to transmit the electronically detectable signal at the delay time after the sound is emitted.

The method depicted in the flowchart of FIG. 2 also includes determining whether the display device is being watched based upon whether the sound that is detected at the sensor compares favorably with the content 82. For example, the set top box may be configured to perform a statistical correlation between the sound provided as content to a display device and the electronically detectable signal as received from the sensor. If the display device has been turned off, then the set top box may determine that no sound at all has been emitted from the display device. If the display device has been turned on, then the set top box may determine that the sound that has been emitted from the display device and retransmitted from the sensor (i.e., the electronically detectable signal) compares favorably with the sound provided as content to the display device.

If desired, the determination of whether the display device is being watched, and whether the sound that is detected at the sensor compares favorably with the content 82, may be performed at a server rather than at the set top box. In other words, the set top box merely retransmits the electronically detectable signal to the server, which has stored a copy of the content that the set top box has provided to the display device.

The determination may include identifying a location (that is, a number of minutes and seconds from a beginning of the content) of the sound segment when each audio codebook was recorded, and retrieving an audio track from an original source stored in a memory, aligning the audio codebook with the audio track, and determining whether the audio codebook matches the audio track. If a match is detected, a determination may be made that the display device was on at the time indicated by the time stamp of the audio codebook, and a conclusion that someone was watching the display device may be made.

The set top box may be able to determine additional information pertaining to the display device from the electronically detectable signal. For example, the set top box may be able to determine a distance between the display device and the sensor. Specifically, any round-trip latency between a first time at which the sound is emitted from the display device and a second time at which the electronically detectable signal is received by the set top box may relate to the distance between the display device and the sensor. Similarly, if the sensor is configured to transmit the electronically detectable signal at a predetermined power level, any attenuation of the power level as the electronically detectable signal is received at the set top box may relate to the distance between the display device and the sensor.

The method depicted in the flowchart of FIG. 2 also includes retransmitting whether the display device is being watched to a control center 84. Specifically, the set top box may retransmit whether the display device is being watched to the control center. The digitally compressed audio codebook may be appended with additional information to create a “sound tag.”

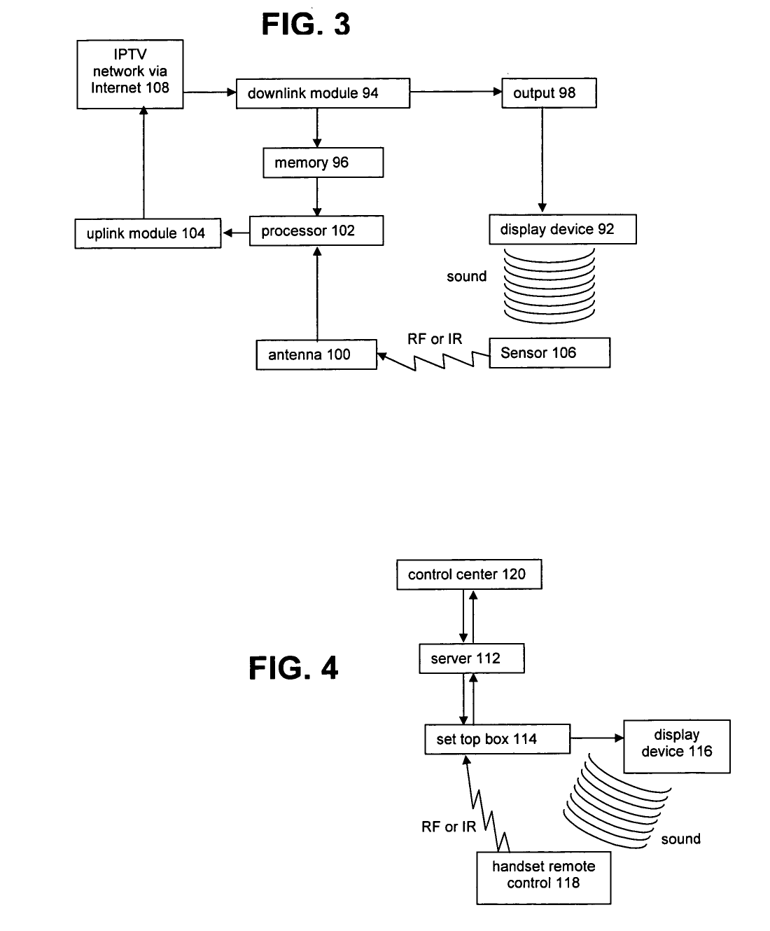

FIG. 3 is a schematic representation of a portion of an STB, in accordance with another embodiment of the present invention. The STB may be an IPTV STB with a capability to upload packetized audio stream, and may also have a downlink module 94 that is operative to receive an IPTV signal or other audio/video content from an IPTV network 108 via the Internet. Accordingly, the content may be IPTV content. For example, the content may be a movie, television program, or other video and/or audio content received from a control center of a broadcasting company.

The STB may also have an output 98 that is configured to transmit the content to one or more display devices, including the display device 92. For example, the set top box may include one or more co-axial cable ports, one or more S-video ports, one or more WiFi or other wireless ports, one or more Bluetooth ports (that is, transmitters), or any other port or ports that either individually or in combination are able to transmit the content to the display device.

At any point along a path that includes the IPTV network 108, the downlink module 94, and the output 98, a memory 96 may be included. In the implementation depicted in FIG. 2, the memory 96 is shown as residing within the set top box, although it should be appreciated that the memory 96 may be located elsewhere, for example within a server that provides content to the downlink module 94 via the Internet. The memory may be implemented as Read Only Memory (RAM), Flash memory, a hard drive, or any other device, component or apparatus capable of storing a portion of the content.

At any point along a path that includes the IPTV network 108, the downlink module 94, and the output 98, additional audio content may be added to the content. The additional audio content may be audible, such as a tone or chime, or may be inaudible, such as an ultrasonic tone at a frequency that is not ordinarily audible to a human ear. The additional audio content may be encoded to identify the STB, and may be added continuously or periodically. The additional audio content may be “auditable” in that the particular STB through which the additional audio content passed en route to the display device 92 may be identified. For example, the additional audio content may include a serial number of the set top box. The audio content may also include a time stamp. In the embodiment depicted in FIG. 2, at least the additional audio content may be stored within the memory 96.

The display device 92 may be a television set, a computer, or other display device that is capable of displaying or playing the content, including the audio content. The display device 92 may be operative to display only a portion of the content, such as a low-definition television signal included within a high-definition television signal, or may be operative to display all of the content. The display device 92 may simply be a pair of stereo speakers operative to present an audio track from a satellite radio signal or Internet Radio signal.

In accordance with the content, which may include the additional audio content, the display device 92 may be configured to emit a sound. The sound may be a special audio signal that is played periodically (for example, every 5 minutes).

The sound is matched to a sensor 106, such as microphone or set of microphones, on a handset remote control corresponding to the display device 92 or to the set top box. The sensor 106 may be configured to be activated by the sound. The handset remote control may also comprise a recorder operative to record the sound (or a portion of the sound). The handset remote control may also contain a frequency modulator capable of generating a radio-frequency (RF) signal containing an electronically readable signal corresponding to the sound, and an antenna operative to transmit the RF signal

The set top box may also include an antenna 100 operative to receive a sound, or the electronically readable signal corresponding to the sound, from a sensor 106 that is distinct from the display device 92. The sound, or the electronically readable signal corresponding to the sound, may be transmitted from a sensor 106 or from several sensors, and may be received by the antenna 100. If the sensors are configured to transmit the electronically detectable signal as an ultrasound signal, the antenna 100 may be replaced with an ultrasound microphone operative to receive the ultrasound signal. For example, the electronically readable signal may be received from a handset remote control that may be an IPTV remote control (RC) with a built-in microphone. The sensor 106 may also record the sound within a memory residing within the handset remote control. The use of omni-directional microphones on the handset remote control may allow a better perception of sound from the display device 92 regardless where handset remote control is placed.

The STB may also include a processor 102 operative to determine whether the display device 92 is being watched. The processor 102 may be a simple comparator, either digital or analog, or may be a complex electronic device capable of performing statistical correlations. The processor 102 may be a simple threshold detector configured to determine whether the electronically detectable signal is present, i.e. whether the electronically detectable signal received at the antenna 100 has an amplitude that exceeds what may be expected from noise. If desired, the processor 102 may be located at a server, rather than at the set top box.

The processor 102 may be configured to perform a statistical comparison between the electronically detectable signal received at the antenna 100 and the content stored in the memory 96. The processor 102 may contain a filter that excludes (or attenuates) any components of the electronically detectable signal that do not correlate favorably with the content in the memory 96. The filter may amplify any components of the electronically detectable signal that correlate favorably with the content in the memory 96.

If the content also includes a serial number of the set top box, then the filter of the processor 102 may also be configured to exclude (or attenuate) the electronically detectable signal if the electronically detectable signal does not contain the serial number. Accordingly, an STB in one room may be enabled to exclude electronically detectable signals received through walls from a display device 92 coupled to another set top box in another room.

The processor 102 thus is operative to produce a “sound tag” that includes a programming code plus a timestamp based on an absolute time at which a given IPTV program is being watched. For example, if the user is watching an IPTV channel #3047 at 8:35 PM Central, the sound unit to be sent to the back end for audio recognition may carry a tag such as “Ch#: 3047; Time: 20:35PM CST.” Alternatively, if the user is watching a movie “Incredible” via a VOD pay-per-view, 15 minutes from the start, the sound unit may carry a different tag such as “Title: Incredible; 0:15”.

Accordingly, the STB or the server may be operative to determine whether the display device 92 is being watched, based upon whether the electronically detectable signal received at the antenna 100 (and received from the sensor 106) compares favorably with the content in the memory 96.

The STB or server may also include an uplink module 104 that is operative to transmit whether the display device 92 is being watched to a control center. The control center may be at a single location, or may be distributed. For example, the control center may include a set of audio recognition servers installed at various IPTV network operation centers. The uplink module 104 may be integrally formed with the downlink module 94, if the downlink module 94/uplink module 104 is bidirectional. The control center may therefore track information pertaining to which channels are being watched by which households using which set top boxes, and may determine when each channel is being watched. If a viewer turns off a television set (e.g., the display device 92 or other display device), then the television set no longer emits the sound, and the processor 102 no longer determines that the television set is being watched.

The control center may include an audio processing system for recognition. From the sound tag, the audio processing system “knows” the location of the sound segment corresponding to a given TV program being watched when this audio codebook was recorded. It retrieves that audio track from the original source and aligns it with the audio codebook. If it is matched, the tracking system will know that the TV was on at that time (and someone was watching).

If a determination is made that all display devices within a network (such as an IPTV network) of display devices have been turned off, then delivery of the content may be discontinued. If all display devices within a branch of the network of display devices have been turned off, then delivery of the content may be discontinued to the branch. A determination may be made periodically, e.g. every five minutes, whether an IPTV program is being watched within the network and within each branch of the network. Service providers may save potentially billions of IP packets sent over an IPTV network to the IPTV sets where no one is watching. This bandwidth saving could ease unnecessary network congestion often caused by spiking demand for certain popular programs during prime time or feeding video on demand (VOD) steams in high definition (HD) format to millions of IPTV homes at one time. As soon as a tracking system recognizes that a given IPTV set has been turned off, it may notify the program feed system to stop sending the IPTV data to that customer location. Since each set top box may append a serial number to whatever it may uplink, the tracking system will not only know when an IPTV program is being watched and for how long, but also know who initially started to watch it.

The network may also discontinue content delivery to set top boxes where a user fails to confirm that the content is being watched. Specifically, if a set top box does not receive an expected number of audio codebooks over a pre-determined time interval (such as every 10 minutes) that match what is supposed to be played on a display device, the network may send an alert video message to the display device (similar to a caller ID), asking the viewer to hit any key on the handset remote control to indicate that the user wants to continue to watch the program. This feature eliminates a potential problem caused by muting the TV or redirecting TV audio to a headset where the handset remote control could not hear any audio from the display device.

FIG. 4 is a schematic diagram of a system, in accordance with yet another embodiment of the present invention. The system includes a server 112, an STB 114, a display device 116, a handset remote control 118, and a control center 120.

The server 112 provides content to the set top box 114, which provides the content to the display device 116. The display device 116 emits a sound, either continuously or periodically and either audibly or inaudibly. The sound may be an ultrasound signal that is not detectable by a human ear. The sound may be, however, detectable by the handset remote control 118, which retransmits an electronically detectable signal to the set top box 114. The STB 114 provides either the electronically detectable signal, or a determination based on the electronically detectable signal, to the server 112. The server 112 either makes a determination based on the electronically detectable signal or retransmits the determination made by the STB 114 to a control center 120.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for determining usage of a display device that emits sound when playing a content comprising:
detecting the sound emitted by the display device at a sensor; and
determining the usage of the display device based upon the sound detected at the sensor.

2. The method of claim 1, further comprising:
receiving the content via an Internet connection such that the content is Internet Protocol Television (IPTV) content.

3. The method for determining usage of a display device of claim 1, wherein:
the sound is not audible to a human ear and is emitted even if the display device is set to mute.

4. The method for determining usage of a display device of claim 1, further comprising:
determining the usage of the display by comparing the sound detected at the server with a predetermined sound.

5. The method for determining usage of a display device of claim 1, wherein:
the sound contains a signal unique to the display device.

6. The method of determining usage of a display device of claim 1, wherein:
the sensor resides within a remote control such that the content may be compared with the detected sound.

7. The method for determining usage of a display device of claim 6, wherein:
detecting the sound is performed with a microphone within the remote control, the remote control being operative to retransmit the sound as electronically detectable signal.

8. The method for determining usage of a display device of claim 1, wherein:
determining the usage of the display device includes correlating the detected sound at the sensor with the content.

9. The method for determining usage of a display device of claim 1, further comprising:
retransmitting information indicative that the display device is in use to a control center.

10. The method for determining usage of a display device of claim 1, wherein determining the usage of the display device;
receiving the content from on control center;
transmitting the content to the display device such that sound is emitted from the display device;
receiving an electronically detectable signal corresponding to the sound emitted from the display device;
comparing the detected sound with the electronically detectable signal; and
retransmitting whether the display device is in use to the control center.

11. A set top box operative to determine usage of a display device, comprising:
an output operative to provide content to a display device, the content containing a sound;
a first input operative to receive at least one of a sound and an electronically readable signal corresponding to the sound from a sensor that is distinct form the display device; and
a processor operative to determine whether the display device is in use based upon whether at least one of a sound and an electronically readable signal corresponding to the sound compares favorably with the content.

12. The set top box of claim 11, further comprising:
an Internet input operative to receive Internet Protocol Television (IPTV), such that the content is IPTV content.

13. The set top box of claim 11, wherein:
the determining is in response to a determining whether the electronically readable signal compares favorably with the content, the electronically readable signal being received from a remote control device operative to provide the electronically readable signal in response to the sound.

14. The set top box of claim 11, further comprising:
an uplink module operative to transmit whether the display device is being watched to a control center.

15. The set top box of claim 11, further operative to perform a method including:
receiving the content form the control center;
transmitting the content to the display device such that the sound is emitted from the display device;
receiving an electronically detectable signal corresponding to the sound;
comparing the sound with the electronically detectable signal; and
retransmitting whether the display device is being watched to the control center.

16. The set top box of claim 15, wherein:
the electronically detectable signal is received from a remote control operative to provide the electronically detectable signal in response to the sound form the display device.

17. The method of claim 1, wherein determining usage of the display device comprises determining at least one of (i) determining a time period for which the display is activated, (ii) determining whether a selected program is displayed on the display device, (iii) determining number of viewers displaying a selected program in a selected region, (iv) determining a time period relating to displaying of a selected program on a display device, (v) determining time period for which a display device is activated, (vi) determining a rating system relating to viewing of a plurality of programs.

18. A method for tracking viewing of contents provided to users wherein the viewers activate a display device when viewing the contents, comprising:
detecting an audio signal associated with the contents being displayed by a user at a user device; and
determining from the detected audio signal a characteristic relating the displaying of contents by the user.
